(19) United States
(12) Patent Application Publication
(10) Pub. No.: US 2009/0051692 A1
(43) Pub. Date: Feb. 26, 2009

(54) Electronic presentation system

(76) Inventor: Jean Margaret Gralley, Potomac Falls, VA (US)

Correspondence Address: HOGAN & HARTSON LLP;IP GROUP, COLUMBIA SQUARE, 555 THIRTEENTH STREET, N.W., WASHINGTON, DC, 20004, US

(21) Appl. No.: 12/081,205

(22) Filed: Apr. 11, 2008

Related U.S. Application Data
(63) Continuation of application No. 11/339,849, filed on Jan. 26, 2006, now abandoned.

(51) Int. Cl. G06T 15/70

(52) U.S. Cl. 345/473

(57) ABSTRACT

The invention provides a digital, animation presentation system for dramatically presenting various works. The digital and animated presentation in accordance with the invention is not limited by the conventions of paper books or electronic books that mimic paper-based books, and provides for the dramatic presentation of animation and animated text that includes text moving forward or backwards across the reader's display as well as appearing to move forward or away from the reader. The invention is applicable to a variety of works, including various fiction and non-fiction stories, educational materials, as well as tutorials and instruction manuals. In accordance with the invention, a reader can control his or her viewing of the digital animation and text so that he or she can view a story in its natural forward progression, pause and/or stop and re-read a section, return to an earlier section and/or skip ahead to a later section. The invention also provides for dramatic presentation and animation of the text as well as animation and sound effects that correlate to the text.

### BACKGROUND OF THE INVENTION

1. Field of the Invention

The invention relates to a digital, animated presentation system, and more particularly to a digital, animated presentation system that enhances the reading experience.

2. Description of the Related Art

Conventional books and reading materials have been in existence for several hundred years. These conventional books and reading materials have traditionally been printed or written onto paper which is then bound. These paper based books present information or a story in a linear fashion so that the reader follows the story or information by simply reading each page and moving to the next page in order to continue reading. Conventional paper books allow a reader to re-read certain pages as well as jump ahead to the end of a story or reread a previous section of the book. Conventional paper based books can also be physically transferred from one location or person to another. Although conventional paper based books have been in existence for hundreds of years, more recently other mechanisms for delivering information in book format have surfaced.

Recently, electronic books have become a popular means for delivering printed information and text to readers. Conventional electronic books (also referred to as e-books) generally re-create a printed page on a reader's screen. A reader can view and read each page as it is reproduced in a linear fashion and then advance to the next page using a user interface such as a mouse or a computer keyboard. In this manner, a reader can read a story or information in the order it is presented while also having the option of moving forward in order to read further along or moving backwards to re-read certain pages. Typically, the screen will display one or two pages at a time. These paperless electronic books can be stored on any electronic media, such as discs and CD-ROM or in a computer's hard drive memory. This makes the electronic books much less bulky than paper-based books.

It is important to note however that electronic books do not alter the reading experience even though there are no actual paper pages that require turning. Electronic books only re-create the static text of paper books. As a result, electronic books do not deviate from the linear reading pattern associated with paper-based books. Some electronic books also simulate the turning of pages so as to re-create the experience of reading a paper-based book. Thus, electronic books, by simulating paper-based books, subject themselves to paper-based limitations and do not offer substantially different reading experience.

Given the advances in computer technology, animation and digital presentation technologies, it would be desirable to provide a system that allows presentation of a story and/or information in a manner that takes advantage of these new technologies and enhances the reading experience while also potentially increasing a reader's comprehension.

### SUMMARY OF THE INVENTION

The invention overcomes the shortcomings of traditional books and electronic books by presenting a story or information in a series of short, digital animated sequences and animated text. In accordance with the invention, a reader can control his or her viewing of the digital animation and text so that he or she can view a story in its natural forward progression, pause and/or re-read a section, return to an earlier section and/or skip ahead to a later section. The invention also provides for dramatic presentation and animation of the text as well as animation and sound effects that correlates to the text. The digital and animated presentation in accordance with the invention is not limited by the conventions of paper books or electronic books that mimic paper-based books, and provides for the dramatic presentation of animation and animated text that includes text moving forward or backwards across the reader's display as well as appearing to move forward or away from the reader.

In accordance with the invention, a story or information is presented to a viewer through the presentation of animation and text that conveys the story in a manner that is appealing to viewers and results in increased comprehension by readers. The invention is particularly appealing to young readers who see a dramatic presentation of the text of a story and also control its progression. The system in accordance with the invention still requires that the user, such as a child, read the text, thus making reading and learning to read more appealing to young readers through animation and dramatic presentation of text.

The invention includes the presentation of sequences of text and animation to readers in a manner that allows readers to read the text while also viewing the related animation sequences. In addition, the text itself may be animated and may change in size, shape, color and font as it is being displayed in a sequence. Each sequence may include one of more panels of text and/animation. In accordance with one embodiment of the invention, there is an automatic pause between each sequence. A reader can then continue the story by using his or her user device interface. In accordance with one embodiment of the invention, readers can also pause the sequences at any time.

The digital, animation presentation system in accordance with the invention is applicable to a variety of works including various fiction and non-fiction stories, educational materials, as well as tutorials and instruction manuals. In accordance with one embodiment of the invention, the text may provide instructions for a project, while the animation will provide a visual demonstration for carrying out the project.

The digital picture book in accordance with the invention may be electronically stored and distributed so that it can be displayed by a user on any electronic media display device, including a hand held e-book reading device, personal computer, and/or portable media player such as the Apple iPod. The display screens of these types of devices provide backlighting so that the digital content can be viewed even in a dark environment.

### BRIEF DESCRIPTION OF THE DRAWINGS

The accompanying drawings, which are included to provide a further understanding of the invention and are incorporated in and constitute a part of this specification, illustrate embodiments of the invention. Together with the written description, these drawings serve to explain the principles of the invention. In the drawings:

FIG. 1 illustrates a conventional paper-based book;

FIG. 2 illustrates a convention electronic book;

FIG. 3 shows a sequence of frames telling part of a story in accordance with the invention;

FIG. 4 shows another sequence of frames telling a part of a story in accordance with the invention;

FIG. 5 shows a single frame with control buttons in accordance with the invention; and

FIG. 6 shows a block diagram of the functional components for implementation of the digital animation presentation system in accordance with an embodiment of the invention.

### DETAILED DESCRIPTION OF THE PREFERRED EMBODIMENTS

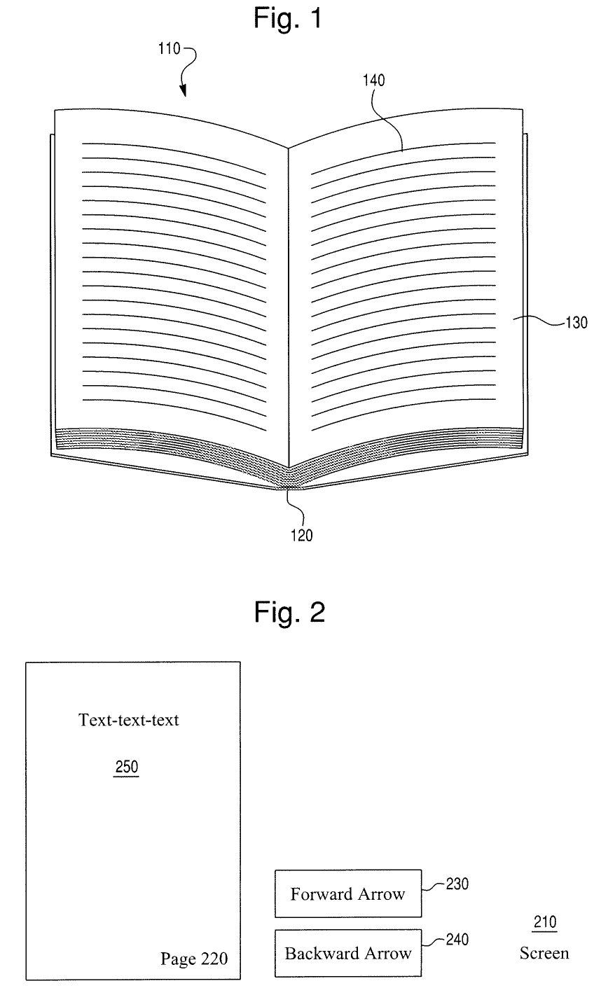

FIG. 1 illustrates a conventional paper-based book 110. As shown in FIG. 1, a conventional book 110 may include pages 130 which are held together by a binding 120. The pages 130 include text 140 which is printed on the surface of the pages 130. Pictures, drawings, charts and other illustrations (not shown) may also be present on the pages 130.

As can be seen in FIG. 1, the reader begins at the top of the page and reads the text and views any pictures on the page until he or she reaches the bottom of the page. The reader then goes to the next page continuing to read the story. Paper based books give the reader the flexibility of turning ahead to the later pages in order to learn what will happen and or flipping backwards to re-read sections. As is discussed earlier, however, these conventional paper based books have numerous drawbacks, including their bulkiness and their need for lighting in order to be read.

FIG. 2 illustrates a displayed page from an conventional electronic book (E-book). FIG. 2 shows a screen 210 which may be any sort of screen display device coupled to a computer, PDA or other digital device. The electronic book may be stored in electronic media and is displayed on the screen 210 when selected by a reader. Typically, a page 220 is displayed on the screen 210. The page 220 may contain text 230 and or illustrations which a reader can read. There may be some variation in the manner in which electronic books display their pages. For example, some electronic books may display a single page at one time on a screen, while other electronic books may simultaneously display multiple pages on a screen. In some cases, the screen 210 will also display forward arrows 230 and backward arrows 240 which allow a reader to navigate through the e-book. Electronic books allow a user to rapidly flip through pages of the text, as well as advance ahead or return to previously read sections. Because e-books can be stored on electronic media, they are typically significantly less bulky than paper books.

As described earlier, the invention provides for animated presentation of a story or other information. The types of stories may include various fictional and non-fictional works including biographies, novels, classic, childrens' books, various educational materials as well as instructional materials. The text of the story may be animated and may move in various directions on the screen. Also, various animated illustrations and sound effects may be provided which correlate to the displayed text. In accordance with the invention, the animation and animated text progress sequence by sequence on the screen. A sequence refers to a group of animated text and/or animated illustrations that is displayed to a reader on the screen. It may also be accompanied by sound effects that also correlate to the text. In this manner, the reader can read a story but that is enhanced by the animation of the text and illustrations. This may result in a greater interest in reading among children as the reading experience becomes more entertaining. It may also result in higher reading comprehension.

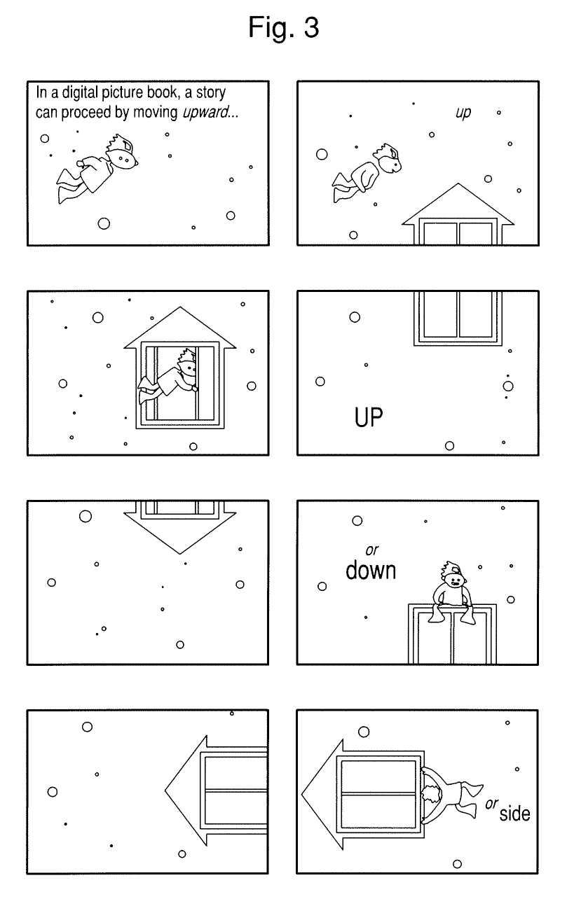

FIGS. 3a-3h illustrate snapshots of an exemplary story sequence that can be displayed by the digital, animated presentation system in accordance with the invention. The snapshots shown in FIGS. 3a-3h illustrate the sentence, “In a digital picture book, a story can proceed by moving upwards, down or sideways.” At the end of the sequence, the story is paused allowing the reader to view the sequence again or move on. FIGS. 3a-3h show how direction, motion, sound and the manipulation of the graphic word are accomplished by the invention and add meaning to the text that is read. FIG. 3a shows the first panel of an exemplary story sequence as it may be shown on a reader's screen. FIG. 3a shows a narrating character floating in space with text appearing over the narrating character's head. The text explains that the digital stories in accordance with the invention need not proceed solely left to right as in a paper-based book, but instead can proceed upwards as well. FIG. 3b shows the next frame of the sequence. In this frame, the sentence begins to fade and the word “up” appears bright while also appearing to grow in size as an arrow enters the frame from below. FIG. 3c shows the next frame where the arrow pauses its upward movement on the frame and the word “up” appears on the crown of the arrow. An audible ding sound will be heard by the reader and the elevator panels will open up. The character swims through the open elevator panels.

In FIG. 3d, the word “up” continues to drift downward and it morphs into capital letters as it moves down the screen to emphasize the upward motion of the arrow/elevator as it proceeds up and out of sight. In FIG. 3e, the arrow is seen returning from the top of the frame. In FIG. 3f, the arrow has proceeded through the frame and the character is now sitting on the top of the flat surface of the arrow. The words “or down” appear on the screen and move upward on the frame as the character and the arrow move downward on the frame. In FIG. 3g, the arrow enters the frame in a left to right direction. In FIG. 3h, the arrow continues to move across the frame and we also see the character clinging to the bottom of the arrow with his legs flailing. The sentence that was started in the earlier frames is now completed with appearance of the words “and sideways” which trail the arrow as it moves across the frame. Once the arrow and character have proceeded across the screen and are out of view, the animation pauses and buttons appear, allowing the reader to choose viewing the sequence again or moving the story along. As demonstrated by FIGS. 3a-3h, the sequence of frames allows a reader to read text that is dramatically presented and which is accompanied by animation that correlates to the text.

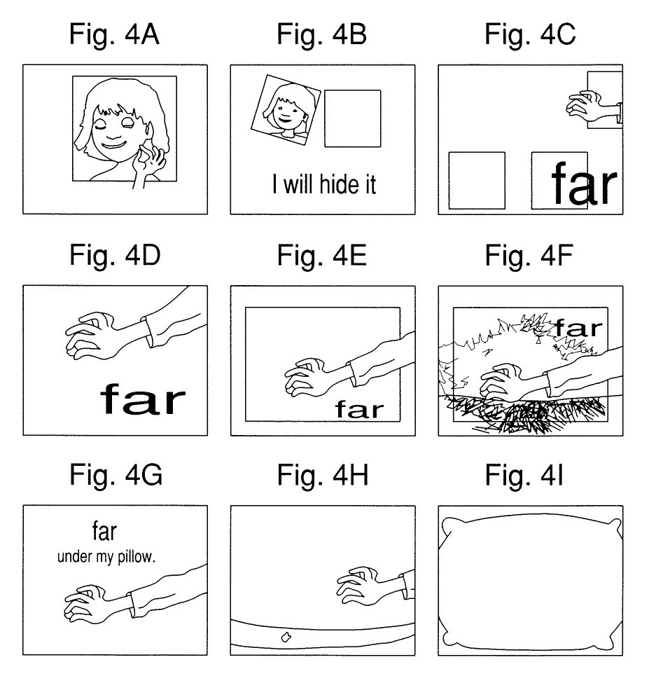

FIGS. 4a-4i illustrate another sequence of frames that tells a story in accordance with the digital, animated presentation system of the invention. FIGS. 4a -4i show snapshots from an animated story about a girl who has lost a tooth. This sequence illustrates the sentence, “I will hide it far under my pillow.” At the end of this sentence, the sequence pauses, allowing the reader to view the sequence again or move the story on.

The sequence begins in FIG. 4a in which the main character of the story holds a tooth between her fingers and waves it back and forth. The next frame, shown in FIG. 4b, the image of the character (girl) is shown and its graphic box is reduced and moved to the upper left hand corner as more boxes appear. As her box begins to tilt, the start of the sentence appears: “I will hide it” and (unseen) the girl leans further to stretch her arm. In FIG. 4c, the girl's hand extends into the frame from the right, her tooth still between her fingers. The word “far” appears in the lower right corner of the frame. In FIG. 4d, the girl's hand appears larger and extends further into the frame. The word “far” also begins to extend. In FIG. 4e, the surface of a bed moves below the girl's arm and the word “far” flattens, giving the illusion of motion and even greater distance. In FIG. 4f, the word “far” has risen and passed behind the arm and starts drifting to the left, as a shadow effect grows.

In FIG. 4g, the word “far” has morphed from black letters to white and alighted atop the words completing the sentence, “under my pillow.” In FIG. 4h, the tooth is left, the arm withdraws, and the background begins to lighten. In FIG. 4i, the view is drawn back and we see a pillow on which the next sentence will appear. At this point the invention pauses and buttons appear (not shown in FIG. 4i), allowing the reader to view the sequence again or move the story along.

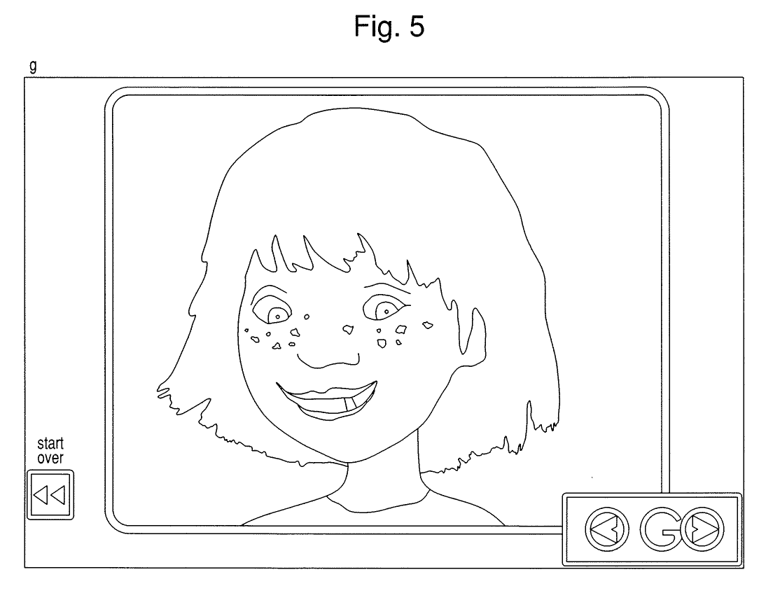

FIG. 5 illustrates a single frame from a story sequence in accordance with the invention. The frame shown in FIG. 5 is the last frame of a sequence. In addition to the face of the character being displayed on the frame, there are also several buttons, 505, 510 and 515 that appear on the screen. The button 505 is a forward button that allows a reader to advance to the next sequence. The button 510 is a backwards button that allows a reader to return to the start of the sequence. Finally, button 515 is a ‘start over’ button that allows the reader to return to the beginning of the story. It should be noted that in other embodiment of the invention, the buttons 505, 510 and 515 do not appear on the frame and the sequences of the story can be advanced by using an interface such as the keys of a keyboard or PDA-type device.

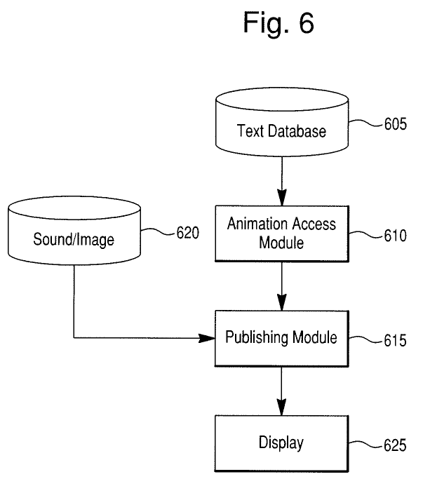

FIG. 6 illustrates a block diagram of the functional components for implementation of the digital animation presentation system in accordance with an embodiment of the invention. FIG. 6 shows a text database 605 communicatively coupled to an animation access module 610. The animation module 610 is also coupled to a publishing module 615. The publishing module 615 is communicatively coupled to a sound and image database 620 and also to a display 625. The text database 605 stores the actual text of the work such as a book or instruction manual. This text is provided by the author or anyone in possession of the text who would like the text presented by the digital animated presentation system in accordance with the invention. The animation access module 610 provides instructions for mapping the text on a reader's screen. These instructions will include the various locations where text will appear and move on the reader's screen. It will also include information about the size, shape, color font and orientation of the text. The animation module 610 also includes instructions regarding the animation and sounds that correlate to the text being displayed. For example, the word “car” in the text may require that an animated car be shown on the screen. In addition, the animation module may also include instructions relating to the movement, position, size, shape and color of the animated object on the reader's screen. In addition, the animation access module 610 will also include instructions relating to the timing for various sound effects that correlate to the text. The animation access module 610 may include a control file that includes filenames of the graphical images that correspond to the text. The control file may also include a timing field that indicates the length of time that each of the graphical images of animation and text should be displaced before being replaced on the screen by the next graphical image. The control file may include an indicator to arrange each of the graphical images and text in the order that the graphical images will be displayed. The data in the control file may be alternatively stored in other formats. For example, the sequencing and timing data may be stored in system memory or the timing data and file names could be stored in a database.

The sound and image database 620 stores actual animation and sound affects which are part of the visual animation presentation system in accordance with the invention. The publishing module 615 includes an animation program which combines the text and animation in accordance with the instructions provided by the animation access module. This combined text and animation is then provided to the display 625 so it can be viewed by the reader. The publisher module 615 organizes and creates sequences which may be made up of one or more frames and which is displayed to the reader. The publishing module 610 may also include an image generator that generates graphical data. In this manner, a reader sees dynamic text which may also be animated combined with correlating animation and sound affects.

In one embodiment of the invention, the text and correlating animation and sound effects are all provided by the author. In another embodiment, the author only provides the text for the story. In this embodiment, the sound and image database 620 stores a library of predetermined animated images and sound effects. Thus, when the text is mapped by the animation access module 610, the publishing module 615 accesses the sound and image database 620 to obtain the predetermined animation and sound effects. The publisher 615 then combines the text with the predetermined animation and sound effects and presents the story to the reader via the display 625.

The animation program described above may be written in any programming language such as C, C++, BASIC, Pascal, and FORTRAN, and can run under any well-known operating system. C, C++, BASIC, Pascal, and FORTRAN are industry standard programming languages for which many commercial compilers can be used to create executable code.

The foregoing description of the preferred embodiments of the invention has been presented for the purposes of illustration and description. It is not intended to be exhaustive or to limit the invention to the precise form disclosed. Many modifications and variations are possible in light of the above teaching.

1. A method for providing a digital animation presentation, comprising the steps of:
parsing a story into at least one sequence;
displaying the at least one sequence on a user display device;
providing means for advancing to a next sequence or returning to a previous sequence,
wherein the at least one sequence includes animation and text, the animation correlating to the text.

2. The method according to claim 1, wherein the text may be animated and may move in any direction on the user display device.

3. The method according to claim 1, wherein animation may move in any direction on the user display device.

4. The method according to claim 1, wherein the at least one of the text size, the text location and the text font will change as the sequence is displayed.

5. The method according to claim 1, wherein the animation will change dynamically in response to the text.

6. The method according to claim 1, wherein the story includes at least one a fictional work, a non-fictional work, a children's story, an educational story, a manual and instructional information.

7. The method according to claim 1, wherein the text dynamically interacts with the animation.

8. The method according to claim 1, wherein the display pauses after one sequence is displayed.

9. The method according to claim 1, wherein the digital animation presentation is presented on one of a handheld display device, a portable media player and a personal computer.

10. The method according to claim 1, wherein the text and animation correlate to one another and interact with one another to enhance reader comprehension.

11. A system for dynamically presenting a story or information, comprising:
a text database for storing text for a story;
an animation database for storing animation that correlates to the text;
an animation access module providing mapping instructions of the text and animation; and
a publishing module for compiling the text and animation to create a story sequence.

12. The system according to claim 11, further including a display device for displaying the story sequence to a reader.

13. The system according to claim 1, wherein the mapping instructions include at least one of an instruction relating to text size, text location, text font, text position, text color, animation size, animation location, animation position and animation color.

14. The system according to claim 11 wherein the animation access module includes a control file containing a timing field for each file name, wherein the timing field indicates the length of time that each individual graphical image is displayed before being replaced by a next graphical image.

15. The system according to claim 14, wherein the control file has an indicator to arrange each of the graphical images and text in an order in which they are to be displayed.

16. The system according to claim 11, wherein the publishing module includes an animation program.

17. The system according to claim 11, wherein the text may be animated and may move in any direction a display device.

18. The system according to claim 11, wherein animation may move in any direction on a display device.

19. The system according to claim 11, wherein at least one of the text size, the text location and the text font will change as the sequence is displayed.

20. The system according to claim 11, wherein the story includes at least one a fictional work, a non-fictional work, a children's story, an educational story, a manual and instructional information.
